(19) United States
(12) Patent Application Publication
(10) Pub. No.: US 2015/0024282 A1
(43) Pub. Date: Jan. 22, 2015

(54) ELECTROLYTE FOR LITHIUM SECONDARY BATTERY AND LITHIUM SECONDARY BATTERY EMPLOYING THE SAME

(71) Applicant: Samsung SDI Co., Ltd., Yongin-si (KR)

(72) Inventors: Ha-Rim Lee, Yongin-si (KR); Sang-Hoon Kim, Yongin-si (KR); In-Haeng Cho, Yongin-si (KR)

(21) Appl. No.: 14/313,905

(22) Filed: Jun. 24, 2014

(30) Foreign Application Priority Data
Jul. 22, 2013 (KR) 10-2013-0086257

(51) Int. Cl. H01M 10/0567; H01M 10/0568; H01M 10/052; H01M 10/0569

(52) U.S. Cl. CPC H01M 10/0567; H01M 10/0569; H01M 10/0568; H01M 10/052; H01M 2300/0025; H01M 2300/0028; H01M 2300/0037; H01M 2300/004
USPC 429/332; 429/188; 429/341; 429/342; 429/338; 429/339; 429/340; 429/337; 429/200

(57) ABSTRACT

In an aspect, a lithium secondary battery including a compound as disclosed and described herein; and an electrolyte for a lithium secondary battery including a non-aqueous organic solvent and a lithium salt is provided.

### INCORPORATION BY REFERENCE TO ANY PRIORITY APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2013-0086257, filed on Jul. 22, 2013, in the Korean Intellectual Property Office, the disclosure of which is incorporated herein in its entirety by reference.

### BACKGROUND

1. Field

This disclosure relates to electrolytes for lithium secondary batteries and lithium secondary batteries including the electrolytes.

2. Description of the Related Technology

Lithium secondary batteries, which are currently receiving much attention as power sources for portable small electronic devices, use organic electrolyte solutions to achieve discharge voltages of two times or greater than that of batteries that use conventional alkali aqueous solutions, and thus, the lithium secondary batteries show high energy densities.

Oxides including lithium may be used as positive active materials of lithium secondary batteries. In particular, lithium oxides including transitional metals, such as LiCoO₂, LiMn₂O₄, and LiNi₁₋ₓCoₓO₂ (0<x<1), have a structure that enables lithium to be intercalated and may be used as positive active materials of lithium secondary batteries. As negative active materials, various forms of carbonaceous materials that may intercalate and deintercalate lithium, including artificial and natural graphite, and hard carbon may be used.

During initial charging of lithium secondary batteries, lithium ions from cathode active materials such as lithium metal oxides move to negative active materials such as graphite and are inserted between layers of negative active materials. As a consequence, electrolyte solutions and carbons of negative active materials react with lithium on surfaces of the negative active materials producing compounds such as Li₂CO₃, Li₂O, and LiOH. The compounds form a type of solid electrolyte interface (SEI) layer on the surfaces of the negative active materials.

However, during the formation of the SEI layer, gases generated from the decomposition of carbonate-based solvents, such as CO, CO₂, CH₄, and C₂H₆, cause expansion of the thickness of the battery during the charging process. Also, over time the SEI layer is gradually destroyed by the increased electrochemical energy and thermal energy while maintained at a high temperature in a fully charged state, such that side reactions, in which exposed electrode surfaces and surrounding electrolyte solutions react, occur continuously. Due to the continuous side reactions, there is a continuous generation of gases, and internal pressures of the batteries may increase, thereby reducing high-temperature stability of the batteries.

To solve the above described problems, research into changing the composition of solvent components or mixing additives therein to change the conditions of SEI layer forming reactions have been conducted.

However, lifespan characteristics of lithium secondary batteries using the electrolytes for lithium secondary batteries known thus far have not reached a satisfactory level, and accordingly, there is much room for improvement.

### SUMMARY

One or more embodiments include electrolytes for lithium secondary batteries and lithium secondary batteries having improved lifespan characteristics by including the electrolytes.

Some embodiments provide an electrolyte for a lithium secondary battery, including: a compound represented by Formula 1; a non-aqueous organic solvent; and a lithium salt;

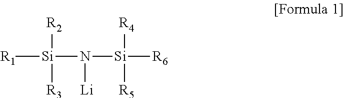

wherein an amount of the compound represented by Formula 1 is about 0.1 wt % to about 3 wt %, and wherein in Formula 1, R₁ to R₆ are each independently a substituted or unsubstituted C₁-C₃₀ alkyl group.

Some embodiments provide a lithium secondary battery including:

a negative electrode including a material that may reversibly intercalate and deintercalate lithium ions, a lithium metal, an alloy of the lithium metal, a material that dopes and undopes lithium, or a negative active material including a transition metal oxide;

a positive electrode including an active material that may reversibly intercalate and deintercalate lithium; and

a reaction product of the electrolyte described above.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a lithium secondary battery according to an embodiment;

FIG. 2 is a graph showing room temperature lifespan characteristics of the rectangular cells prepared in Manufacturing Example 1 and Comparative Manufacturing Example 1;

FIG. 3 is a graph showing room temperature lifespan characteristics of the rectangular cells prepared according to Manufacturing Example 1 and Comparative Manufacturing Examples 1-3; and

FIG. 4 is a graph showing high temperature lifespan characteristics of the rectangular cells prepared in Manufacturing Example 1 and Comparative Manufacturing Example 1.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list. Additional aspects will be set forth in part in the description which follows and, in part, will be apparent from the description, or may be learned by practice of the presented embodiments.

One or more embodiments include an electrolyte for a lithium secondary battery including a non-aqueous organic solvent; a lithium salt; and a compound represented by Formula 1 below.

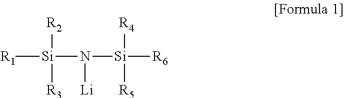

In Formula 1, R₁ to R₆ are each independently a substituted or unsubstituted C₁-C₃₀ alkyl group.

In some embodiments of Formula 1, R₁ to R₆ may each independently be a methyl group, an ethyl group, a propyl group, a pentyl group, or a hexyl group.

In some embodiments of Formula 1, R₁ to R₆ are each methyl. In some embodiments of Formula 1, R₁ to R₆ are each ethyl. In some embodiments of Formula 1, R₁ to R₆ are propyl.

In some embodiments, the compound of Formula 1 may be a compound represented by Formula 2:

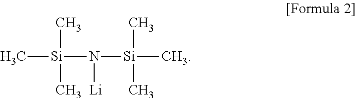

During the operation of a battery HF (hydrogen fluoride) or water may be produced in the electrolyte. HF (hydrogen fluoride) and water are factors detrimental to the lifespan of a battery and accordingly. In some embodiments, the compound of Formula 1 may be used for scavenging HF and water to improve the lifespan of a battery. HF (hydrogen fluoride) is known for dissolving positive active materials, and water may react with an electrolytic solution to form products such as HF and POF₃ to bring about continuous side reactions.

In some embodiments, the amount of the compound of Formula 1 present in the electrolyte may be about 0.01 wt % to about 3 wt % based on the total amount of the electrolyte, In some embodiments, the amount of the compound of Formula 1 present in the electrolyte may be about 0.1 wt % to about 1 wt % based on the total amount of the electrolyte. When the amount of the compound represented by Formula 1 is in the ranges above, improvements in lifespan characteristics of the lithium secondary battery are excellent.

As used herein, “Cₐ to C_{b}” or “C_{a-b}” in which “a” and “b” are integers refer to the number of carbon atoms in the specified group. That is, the group can contain from “a” to “b”, inclusive, carbon atoms. Thus, for example, a “C1 to C4 alkyl” or “C₁₋₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—.

As used herein the term “alkyl” refers to a linear or a branched saturated monovalent hydrocarbon having 1 to 40 carbons atoms. In some embodiment, the alkyl may have 1 to 20 carbon atoms. In some embodiment, the alkyl may have 1 to 10 carbon atoms. In some embodiments, the alkyl may have 1 to 6 carbon atoms. In some embodiments, the alkyl may be substituted or unsubstituted

For example, an unsubstituted alkyl group may be selected from the group consisting of methyl, ethyl, propyl, isobutyl, sec-butyl, tert-butyl, pentyl, iso-amyl, and hexyl. In some embodiment, the alkyl may be substituted with one or more selected from the group consisting of a halogen atom, a hydroxy group, a nitro group, a cyano group, a substituted or unsubstituted amino group (—NH₂, —NH(R), —N(R′)(R″), wherein R, R′ and R″ are each independently a C₁-C₁₀ alkyl group), an amidino group, hydrazine or a hydrazone group, a carboxyl group, a sulfonic acid group, a phosphoric acid group, a C₁-C₂₀ halogenated alkyl group, a C₂-C₂₀ alkenyl group, a C₂-C₂₀ alkynyl group, a C₁-C₂₀ heteroalkyl group, a C₆-C₂₀ aryl group, a C₇-C₂₀ arylalkyl group, a C₁-C₂₀ heteroaryl group, or a C₂-C₂₀ heteroarylalkyl group.

As used herein, the term “alkenyl” refers to an acyclic hydrocarbon group of from two to twenty carbon atoms containing at least one carbon-carbon double bond including, but not limited to, ethenyl, 1-propenyl, 2-propenyl, 2-methyl-1-propenyl, 1-butenyl, 2-butenyl, and the like. In some embodiments, alkenyls may be substituted or unsubstituted. In some embodiments, the alkenyl may from 2 to 40 carbon atoms.

As used herein, the term “alkynyl”refers to a hydrocarbon group of from two to twenty carbon atoms containing at least one carbon-carbon triple bond including, but not limited to, ethynyl, 1-propynyl, 1-butynyl, 2-butynyl, and the like. In some embodiments, alkynyls may be substituted or unsubstituted. In some embodiments, the alkynyl may have from 2 to 4 carbon atoms.

As used herein, “heteroalkyl” means an alkyl group containing at least one heteroatom.

As used herein, the term “halogenated alkyl” or “haloalkyl” refers to an alkyl substituted with at least one halogen atom.

As used herein, the term “fluoroalkyl” refers to an alkyl substituted with at least one fluoro group.

As used herein, the term “aromatic” refers to a ring or ring system having a conjugated pi electron system and includes both carbocyclic aromatic (e.g., phenyl) and heterocyclic aromatic groups (e.g., pyridine). The term includes monocyclic or fused-ring polycyclic (i.e., rings which share adjacent pairs of atoms) groups provided that the entire ring system is aromatic.

As used herein, the term “aryl” refers to an aromatic ring or ring system (i.e., two or more fused rings that share two adjacent carbon atoms) containing only carbon in the ring backbone. When the aryl is a ring system, every ring in the system is aromatic. Examples of aryl groups include, but are not limited to, phenyl, biphenyl, naphthyl, phenanthrenyl, naphthacenyl, and the like. In some embodiments, aryls may be substituted or unsubstituted.

As used herein, the term “heteroaryl” refers to an aromatic ring system radical in which one or more ring atoms are not carbon, namely heteroatom, having one ring or multiple fused rings. In fused ring systems, the one or more heteroatoms may be present in only one of the rings. Examples of heteroatoms include, but are not limited to, oxygen, sulfur and nitrogen. Examples of heteroaryl groups include, but are not limited to, furanyl, thienyl, imidazolyl, quinazolinyl, quinolinyl, isoquinolinyl, quinoxalinyl, pyridinyl, pyrrolyl, oxazolyl, indolyl, and the like.

As used herein, the term “arylalkyl” refers to an aryl group connected, as a substituent, via an alkylene group, such as “C₇₋₁₄ arylalkyl” and the like, including but not limited to benzyl, 2-phenylethyl, 3-phenylpropyl, and naphthylethyl. In some cases, the alkylene group is a lower alkylene group (i.e., a C₁₋₄ alkylene group).

As used herein, the term “heteroarylalkyl” refers to an heteroaryl group connected, as a substituent, via an alkylene group.

The non-aqueous organic solvent performs the role of a medium through which ions contributing to an electrochemical reaction of a battery may move.

In some embodiments, the non-aqueous organic solvent may be a carbonate-based, an ester-based, an ether-based, a ketone-based, an alcohol-based, or an aprotic solvent.

In some embodiments, the carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC) or the like, and the ester-based solvent may be methyl acetate, ethyl acetate, n-propyl acetate, dimethylacetate, methyl propionate, ethyl propionate, γ-butylolactone, decanolide, valerolactone, mevalonolactone, caprolactone, or the like.

In some embodiments, the ether-based solvent may be dibutyl ether, tetraglyme, diglyme, dimethoxy ethane, 2-methyl tetrahydrofuran, tetrahydrofuran, or the like, and the ketone-based solvent may be cyclohexanone or the like. In some embodiments, the alcohol-based solvent may be ethyl alcohol, isopropyl alcohol, or the like, and the aprotic solvent may be a nitrile such as R—CN (wherein, R is a C₂-C₂₀ linear, branched or cyclic hydrocarbon chain, an amide such as dimethyl formamide, a dioxolane such as 1,3-dioxolane, or a sulfolane.

In some embodiments, the non-aqueous organic solvent may be used alone or by mixing two or more thereof, and when a mixture of two or more non-aqueous organic solvents is used, a mixture ratio may be suitably adjusted according to the desired battery performance, and this is well known to one of ordinary skill in the art.

Also, in the case of a carbonate-based solvent, a mixture of cyclic carbonate and chain carbonate is used. In some embodiments, the cyclic carbonate and the chain carbonate may be mixed in a volume ratio of about 1:1 to about 1:9 to show excellent performance of the electrolyte solution.

In some embodiments, the non-aqueous organic solvent may further include the aromatic hydrocarbon-based organic solvent in the carbonate-based solvent. Here, the carbonate-based solvent and the aromatic hydrocarbon-based organic solvent may be mixed in a volume ratio of about 1:1 to about 30:1.

In some embodiments, the aromatic hydrocarbon-based organic solvent may be an aromatic hydrocarbon-based compound represented by Formula 3:

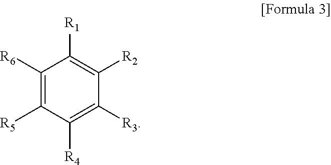

wherein, in Formula 3, R₁ to R₆ may be each independently hydrogen, halogen, a C₁-C₁₀ alkyl group, a C₁-C₁₀ haloalkyl group, or a combination thereof.

In some embodiments, the aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

In some embodiments, the non-aqueous electrolyte may further include vinylene carbonate or an ethylene carbonate-based compound to increase the lifespan of a battery. In some embodiments, the vinylene carbonate may be a compound represented by Formula 4:

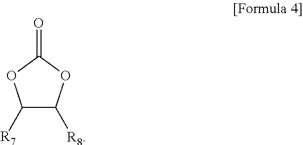

wherein, in Formula 4, R₇ and R₈ are each independently hydrogen, a halogen atom, a cyano group (CN), a nitrogen group (NO₂), or a C₁-C₅ fluoroalkyl group, wherein at least one of R₇ and R₈ may be a halogen group, a cyano group (CN), a nitro group (NO₂), or a C1-C5 fluoroalkyl group.

Representative examples of the ethylene carbonate-based compound include difluoro ethylene carbonate, chloroethylene carbonate, dichloroethylene carbonate, bromoethylene carbonate, dibromoethylene carbonate, nitroethylene carbonate, cyanoethylene carbonate, and fluoroethylene carbonate. When the vinylene carbonate or the ethylene carbonate-based compound is further used, the used amounts thereof may be suitably adjusted to improve the lifespan of a battery.

In some embodiments, the lithium salt may be dissolved in the non-aqueous organic solvent to act as a supply source of lithium ions in a battery and thereby enable the operation of a basic lithium secondary battery, and the lithium salt is a material that catalyzes the mobility of lithium ions between a positive electrode and a negative electrode. Representative examples of the lithium salt include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers of 1 to 20, respectively), LiCl, LiI, LiB(C₂O₄)₂(lithium bis(oxalato)borate), or a combination thereof, and the lithium salt is included as a supporting electrolyte salt. In some embodiments, the concentration of the lithium salt is in a range of about 0.1 M to about 2.0 M.

When the concentration of the lithium salt is in the range above, the electrolyte may have suitable conductivity and viscosity for achieving excellent electrolyte performance, and lithium ions may move efficiently.

In some embodiments, the non-aqueous organic solvent includes a mixture solvent of ethylene carbonate (EC) and ethylmethyl carbonate (EMC), or a mixture solvent of ethylene carbonate (EC), ethylmethyl carbonate (EMC), and diethylene carbonate (DEC).

In some embodiments, a volume ratio of ethylene carbonate (EC) and ethylmethyl carbonate (EMC) in the mixture solvent of ethylene carbonate (EC) and ethylmethyl carbonate (EMC) may be 3:7, and a volume ratio of ethylene carbonate (EC), ethylmethyl carbonate (EMC), and diethylene carbonate (DEC) in the mixture solvent of ethylene carbonate (EC), ethylmethyl carbonate (EMC), and diethylene carbonate (DEC) may be 3:5:2. When either of the mixture solvents having the above-described volume ratios is used as the non-aqueous organic solvent, a high dielectric permittivity of the cyclic carbonate solvent and low viscosity of the linear carbonate solvent may be suitably combined to obtain higher ion conductivity. Also, since DEC has high boiling point, it is advantageous for manufacturing the battery with improved lifespan at a high temperature.

Some embodiments provide a lithium secondary battery including a negative electrode; a positive electrode; and an electrolyte as disclosed and described herein.

The negative electrode is a negative active material that includes a material that may reversibly intercalate and deintercalate lithium ions. In some embodiments, the material may include a lithium metal, an alloy of the lithium metal, and a material that may dope and undope lithium, and a transitional metal oxide.

In some embodiments, the positive electrode includes a material that may reversibly intercalate and deintercalate lithium as the positive active material.

In some embodiments, the electrolyte includes a non-aqueous organic solvent; a lithium salt; and a compound represented by Formula 1, wherein the amount of the compound represented by Formula 1 is about 0.1 wt % to about 3 wt %.

Hereinafter, processes for manufacturing a lithium secondary battery by using the electrolyte as disclosed and described herein and a method of manufacturing a lithium secondary battery having a positive electrode, a negative electrode, an electrolyte as disclosed and described herein, and a separator will be described.

In some embodiments, a composition for forming a positive active material layer and a composition for forming a negative active material layer are each coated and dried on a current collector to prepare the positive electrode and the negative electrode.

In some embodiments, a positive active material, a conductor, a binder, and a solvent are mixed to prepare the composition for forming the positive active material layer, and a lithium composite oxide represented by Formula 2 described above may be used as the positive active material.

In some embodiments, the positive active material may be a compound that may reversibly intercalate and deintercalate lithium (i.e., a lithiated intercalation compound).

In some embodiments, the positive active material may be at least one selected from a lithium cobalt oxide of LiCoO₂; a lithium nickel oxide represented by formula LiNiO₂; a lithium manganese oxide represented by formula Li₁₊ₓMn₂₋ₓO₄ (wherein, x is about 0 to about 0.33), LiMnO₃, LiMn₂O₃, or LiMnO₂; a lithium copper oxide represented by formula Li₂CuO₂; a lithium iron oxide represented by formula LiFe₃O₄; a lithium vanadium oxide represented by formula LiV₃O₈; a copper vanadium oxide represented by formula Cu₂V₂O₇; a vanadium oxide represented by formula V₂O₅; a Ni-site-type lithium nickel oxide represented by formula LiNi₁-MₓO₂ (wherein, M=Co, Mn, Al, Cu, Fe, Mg, B (boron), or Ga, and x=about 0.01 to about 0.3); a lithium manganese composite oxide represented by Formula LiMn₂₋ₓMₓO₂ (wherein, M=Co, Ni, Fe, Cr, Zn or Ta, and x=about 0.01 to about 0.1), or Li₂Mn₃MO₈ (wherein, M=Fe, Co, Ni, Cu, or Zn); a lithium manganese oxide represented by formula LiMn₂O₄, in which some of Li are substituted with alkaline earth metal ions; a disulfide compound; and an iron molybdenum oxide represented by formula Fe₂(MoO₄)₃.

In some embodiments, the positive active material may be, for example, a mixture of a lithium cobalt oxide and a lithium nickel cobalt manganese oxide.

A binder for the positive electrode may be a binder composition according to an embodiment of the present disclosure or may be anything that thoroughly bonds positive active material particles together and attaches the positive active material to a current collector. Representative examples of the binder include polyvinyl alcohol, carboxy methyl cellulose, hydroxyl propyl cellulose, diacetyl cellulose, polyvinyl chloride, carboxylated polyvinyl chloride, polyvinyl fluoride, ethylene oxide containing polymer, polyvinyl pyrrolidone, polyurethane, polytetrafluoroethylene, polyvinylidene fluoride, polyethylene, polypropylene, styrene-butadienne rubber, acrylated styrene-butadienne rubber, epoxy resin, and nylon, and any one of these may be used.

In some embodiments, at least one selected from the group consisting of lithium cobalt oxide, lithium nickel cobalt manganese oxide, lithium nickel cobalt aluminum oxide, lithium iron phosphate, and lithium manganese oxide may be used as the positive active material, but the positive active material is not limited thereto, and any positive active material used in the art may be used.

In some embodiments, a compound represented by any one represented by formulae below may be used:

LiₐA_{1-b}B¹_{b}D¹₂ (wherein, 0.90≦a≦1.8 and 0≦b≦0.5);

LiₐE_{1-b}B¹_{b}O_{2-c}D¹_{c} (wherein, 0.90≦a≦1.8, 0≦b≦0.5, and 0≦c≦0.05);

LiE_{2-b}B¹_{b}O_{4-c}D¹_{c} (wherein, 0≦b≦0.5 and 0≦c≦0.05);

LiₐNi_{1-b-c}Co_{b}B¹_{c}D¹_{α} (wherein, 0.90≦a≦1.8, 0≦b≦0.5, 0≦c≦0.05, and 0<α≦2);

LiₐNi_{1-b-c}Co_{b}B¹_{c}O_{2-α}F¹_{α} (wherein, 0.90≦a≦1.8, 0≦b≦0.5, 0≦c≦0.05, and 0<α<2);

LiₐNi_{1-b-c}Co_{b}B¹_{c}O_{2-α}F¹₂ (wherein, 0.90≦a≦1.8, 0≦b≦0.5, 0≦c≦0.05, and 0<α<2);

LiₐNi_{1-b-c}Mn_{b}B¹_{c}D¹_{α} (wherein, 0.90≦a≦1.8, 0≦b≦0.5, 0≦c≦0.05, and 0<α≦2);

LiₐNi_{1-b-c}Mn_{b}B¹_{c}O_{2-α}F¹_{α} (wherein, 0.90≦a≦1.8, 0≦b≦0.5, 0≦c≦0.05, and 0<α<2);

LiₐNi_{1-b-c}Mn_{b}B^{l}_{c}O_{2-α}F¹₂ (wherein, 0.90≦a≦1.8, 0≦b≦0.5, 0≦c≦0.05, and 0<α<2);

LiₐNi_{b}E_{c}G_{d}O₂ (wherein, 0.90≦a≦1.8, 0≦b≦0.9, 0≦c≦0.5, and 0.001≦d≦0.1);

LiₐNi_{b}Co_{c}Mn_{d}GₑO₂ (wherein, 0.90≦a≦1.8, 0≦b≦0.9, 0≦c≦0.5, 0≦d≦0.5, and 0.001≦e≦0.1);

LiₐNiG_{b}O₂ (wherein, 0.90≦a≦1.8 and 0.001≦b≦0.1);

LiₐCoG_{b}O₂ (wherein, 0.90≦a≦1.8 and 0.001≦b≦0.1);

LiₐMnG_{b}O₂ (wherein, 0.90≦a≦1.8 and 0.001≦b≦0.1);

LiₐMn₂G_{b}O₄ (wherein, 0.90≦a≦1.8 and 0.001≦b≦0.1); QO₂; QS₂; LiQS₂; V₂O₅; LiV₂O₅; LiI¹O₂; LiNiVO₄; Li_{(3-f)}J₂(PO₄)₃ (0≦f≦2); Li_{(3-f)}Fe₂(PO₄)₃ (0≦f≦2); and LiFePO₄.

In the Formulae above, A may be Ni, Co, Mn, or a combination thereof; B¹ may be Al, Ni, Co, Mn, Cr, Fe, Mg, Sr, V, a rare earth element, or a combination thereof; D¹ may be O (oxygen), F (fluorine), S (sulfur), P (phophorus), or a combination thereof; E may be Co, Mn, or a combination thereof; F¹ may be F (fluorine), S (sulfur), P (phosphorus), or a combination thereof; G may be Al, Cr, Mn, Fe, Mg, La, Ce, Sr, V, or a combination thereof; Q may be Ti, Mo, Mn, or a combination thereof; I¹ may be Cr, V, Fe, Sc, Y, or a combination thereof; and J may be V, Cr, Mn, Co, Ni, Cu, or a combination thereof.

As the positive active material, the above-described compound having a coating layer on the surface of the compound may be used, or a mixture of the compound and the compound having a coating layer may be used. In some embodiments, the coating layer may include a coating element compound such as an oxide or a hydroxide of a coating element, an oxyhydroxide of a coating element, an oxycarbonate of a coating element, or a hydroxycarbonate of a coating element. In some embodiments, the compounds forming the coating layer may be amorphous or crystalline. In some embodiments, the coating elements included in the coating layer may be Mg, Al, Co, K, Na, Ca, Si, Ti, V, Sn, Ge, Ga, B, As, Zr or a mixture thereof. Any coating method that uses the compounds listed above but does not negatively affect properties of the positive active material (for example, spray coating and dipping method), and detailed descriptions of the methods will be omitted because the methods are well known to one of ordinary skill in the art.

In some embodiments, the binder is a component that facilitates bonding between the positive active material layer and the current collector, and the binder is added in the amount of about 1 part by weight to about 50 parts by weight based on 100 parts by weight of the total weight of the positive active material. Non-limiting examples of the binder include polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene-butadiene rubber, fluoro rubber, and various copolymers. In some embodiments, the amount of the binder used may be about 2 parts by weight to about 5 parts by weight based on 100 parts by weight of the total weight of the positive active material. When the amount of the binder is in the range above, bonding strength of the active material layer to the current collector is good.

In some embodiments, the conductor may be anything that has conductivity but does not cause chemical changes to the battery, for example, graphite such as natural graphite and artificial graphite; a carbonaceous material such as carbon black, acetylene black, ketjen black, channel black, furnace black, lamp black, and thermal black; a conductive fiber such as carbon fiber and metal fiber; a fluorocarbon, aluminum, a metal powder such as nickel powder; a conductive whisker such as zinc oxide and potassium titanate; a conductive metal oxide such as titanium oxide; a conductive material such as polyphenylene derivatives.

In some embodiments, the amount of the conductor may be about 2 parts by weight to about 5 parts by weight based on 100 parts by weight of the total weight of the positive active material. When the amount of the conductor is within the range above, conductivity of the finally obtained electrode is excellent.

A non-limiting example of the solvent includes N-methylpyrrolidone.

In some embodiments, the amount of the solvent may be about 100 parts by weight to about 2000 parts by weight based on 100 parts by weight of the positive active material. When the amount of the solvent is within the range above, the process for forming the active material layer is easy.

In some embodiments, the positive electrode current collector has a thickness of about 3 μm to about 500 μm, and any positive electrode current collector that has high conductivity but does not cause chemical changes to the battery may be used, for example, stainless steel, aluminum, nickel, titanium, heat-treated carbon, or surface treated aluminum or stainless steel with carbon, nickel, titanium, silver, or the like. In some embodiments, a small irregularity may be formed on a surface of the current collector to increase the bonding strength of the positive active material, and the current collector may be used in various forms such as a film, a sheet, a foil, a net, a porous body, foam, and a non-woven fabric.

Separately, a negative active material, a binder, a conductor, and a solvent are mixed to prepare a composition for a negative active material layer.

In some embodiments, the negative active material is a material that may intercalate and deintercalate lithium ions. Non-limiting examples of the negative active material include graphite, a carbonaceous material such as carbon, a lithium metal, an alloy of the lithium metal, and a silicon-oxide-based material. In some embodiments, the negative active material may include silicon oxide.

In some embodiments, the carbonaceous material may be a crystalline carbon, an amorphous carbon, or a mixture thereof. In some embodiments, the crystalline carbon may be graphite such as natural graphite or artificial graphite having amorphous form, flat form, flake form, spherical form, or fiber form. In some embodiments, the amorphous carbon may be a soft carbon (low temperature calcined carbon) or a hard carbon, a mesophase pitch carbide, calcined cokes, graphene, carbon black, fullerene soot, carbon nanotubes, and carbon fiber, but the amorphous carbon is not limited thereto and anything that may be used in the art may be used.

In some embodiments, the binder is added in an amount of about 1 part by weight to about 50 parts by weight based on 100 parts by weight of the total weight of the negative active material. Non-limiting examples of the binder are the same as that of the positive electrode.

In some embodiments, the amount of the conductor used may be about 1 part by weight to about 5 parts by weight based on 100 parts by weight of the total weight of the negative active material. When the amount of the conductor is in the range above, conductivity of the finally obtained electrode is excellent.

In some embodiments, the amount of the solvent used is about 100 parts by weight to about 2000 parts by weight based on 100 parts by weight of the total weight of the negative active material. When the amount of the solvent is within the range above, the process for forming the negative active material layer is easy.

In some embodiments, the same types of materials as those for preparing the positive electrode may be used for the conductor and the solvent.

In some embodiments, the negative electrode current collector may have a thickness of about 3 μm to about 500 μm, and any negative electrode current collector that has high conductivity but does not cause chemical changes to the battery may be used, for example, copper, stainless steel, aluminum, nickel, titanium, heat-treated carbon, or surface treated copper or stainless steel with carbon, nickel, titanium, silver, or the like. As in the case of the positive current collector, a small irregularity may be formed on a surface of the current collector to increase the bonding strength of the negative active material, and the current collector may be used in various forms such as a film, a sheet, a foil, a net, a porous body, foam, and a non-woven fabric.

In some embodiments, a separator is disposed between the positive electrode and the negative electrode prepared according to the above-described processes.

In some embodiments, a diameter of a hole of the separator is generally about 0.01 μm to about 10 μm and a thickness of the separator is generally about 5 μm to about 20 μm. As the separator, for example, an olefin-based polymer such as chemical resistant and hydrophobic polypropylene; or a sheet or a non-woven fabric formed of glass fiber or polyethylene is used. When a solid electrolyte such as polymer is used as an electrolyte, the solid electrolyte may include a separator film.

Detailed examples of the olefin-based polymer in the separator include polyethylene, polypropylene, polyvinylidene fluoride, and a multilayer film of two or more layers thereof. In addition, a mixture multilayer film such as a polyethylene/polypropylene double layer separator, a polyethylene/polypropylene/polyethylene triple layer separator, or a polypropylene/polyethylene/polypropylene triple layer separator may be used.

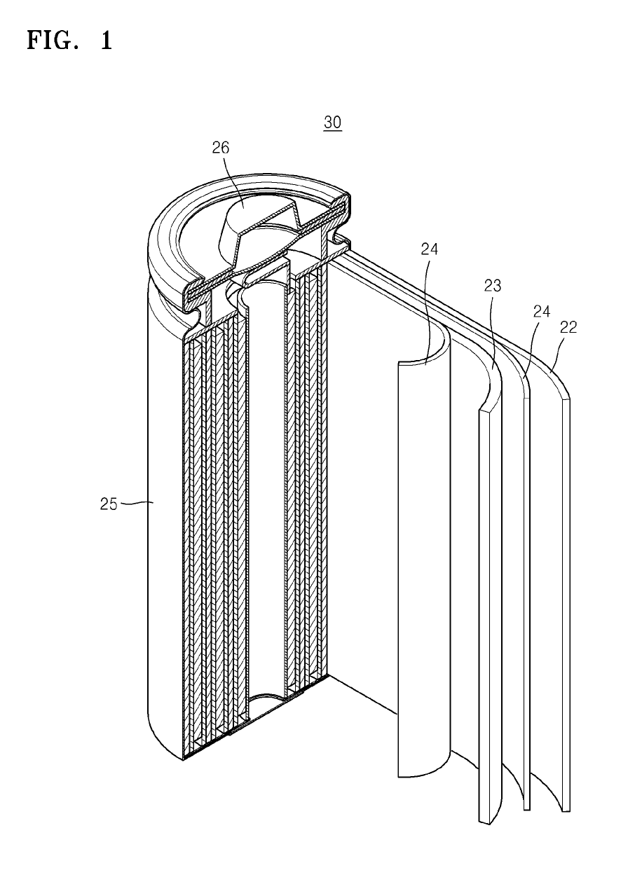

FIG. 1 is a schematic view of a representative structure of a lithium secondary battery 30 according to an embodiment of the present disclosure.

Referring to FIG. 1, the lithium secondary battery 30 primarily includes a positive electrode 23, a negative electrode 22, and a separator 24 disposed between the positive electrode 23 and the negative electrode 22, an electrolyte (not shown) impregnated in the positive electrode 23, the negative electrode 22, and the separator 24, and a cap assembly 26 that seals the battery case 25. In some embodiments, the lithium secondary battery 30 may have the positive electrode 23, the negative electrode 22, and the separator 24 that are sequentially laminated, and then rolled in a spiral form to be enclosed in the battery case 25. In some embodiments, the battery case 25 may be sealed along with the sealing member 26 to complete the lithium secondary battery 30.

Hereinafter, Examples and Comparative Examples will be described. However, Examples below are for illustrative purposes only and the present embodiments are not limited to the Examples.

### EXAMPLE 1

### Preparation of an Electrolyte

LiPF₆ was added to 30 volume % of ethylene carbonate (EC) and 70 volume % of ethylmethyl carbonate (EMC) to prepare 1M LiPF₆ solution, and lithium bis(trimethylsilyl)amide represented by formula 2 was added to the 1M LiPF₆ solution in the amount of 1.0 wt % based on 100 wt % of the total weight of an electrolyte to prepare an electrolyte.

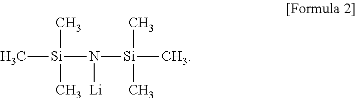

### EXAMPLE 2

### Preparation of an Electrolyte

LiPF₆ was added to 30 volume % of ethylene carbonate (EC), and 70 volume % of ethylmethylcarbonate (EMC) to prepare 1M LiPF₆ solution, and lithium bis(trimethylsilyl)amide represented by formula 2 was added to the 1M LiPF₆ solution, in the amount of 0.1 wt % based on 100 wt % of the total weight of an electrolyte to prepare an electrolyte.

### EXAMPLE 3

### Preparation of an Electrolyte

LiPF₆ was added to 30 volume % of ethylene carbonate (EC), and 70 volume % of ethylmethylcarbonate (EMC) to prepare 1M LiPF₆ solution, and lithium bis(trimethylsilyl)amide represented by formula 2 was added to the 1M LiPF₆ solution, in the amount of 3.0 wt %, based on 100 wt % of the total weight of an electrolyte to prepare an electrolyte.

### COMPARATIVE EXAMPLE 1

### Preparation of an Electrolyte

An electrolyte was prepared in the same manner as in Example 1, except that lithium bis(trimethylsilyl)amide represented by formula 2 was not added.

### COMPARATIVE EXAMPLE 2

### Preparation of an Electrolyte

An electrode was prepared in the same manner as in Example 1, except that the amount of lithium bis(trimethylsilyl)amide represented by formula 2 was 0.05 wt %.

### COMPARATIVE EXAMPLE 3

### Preparation of an Electrolyte

An electrode was prepared in the same manner as in Example 1, except that the amount of lithium bistrimethylsilyl amide represented by formula 2 was 5 wt %.

### MANUFACTURING EXAMPLE 1

### Preparation of a Rectangular Cell

LiNi_{0.5}Co_{0.2}Mn_{0.3} as a positive active material, polyvinylidene fluoride (PVDF) as a binder, and carbon as a conductor were each mixed in a weight ratio of 92:4:4, which was then dispersed in N-methyl-2-pyrrolidone to prepare a composition for an active material layer. The composition for an active material layer was coated on an aluminum foil having a thickness of 20 μm, which was then dried and roll-pressed to prepare a positive electrode.

Crystalline artificial graphite as a negative active material and polyvinylidene fluoride (PVDF) as a binder were mixed in a weight ratio of 92:8 to be dispersed in N-methyl-2-pyrrolidone to prepare a composition for a negative active material layer. The composition for a negative active material layer was coated on a copper foil having a thickness of 15 μm, which was then dried and roll-pressed to prepare a negative electrode.

A separator formed of polyethylene material having a thickness of 16 μm was disposed between the prepared positive electrode and the negative electrode, and an electrolyte was injected thereto to prepare a rectangular cell. Here, the electrolyte of Example 1 was used as the electrolyte.

### MANUFACTURING EXAMPLES 2 AND 3

### Preparation of a Rectangular Cell

Rectangular cells were prepared in the same manner as in Example 1, except that the electrolytes of Examples 2 and 3 were used respectively.

### COMPARATIVE MANUFACTURING EXAMPLES 1-3

### Preparation of Rectangular Cells

Rectangular cells were prepared in the same manner as in Manufacturing Example 1, except that the electrolytes of Examples 1-3 were used respectively, instead of the electrolyte of Example 1.

### EVALUATION EXAMPLE 1

### Evaluation of Charge and Discharge Characteristics and Lifespan Characteristics at Room Temperature

### 1) EXAMPLE 1 AND COMPARATIVE EXAMPLE 1

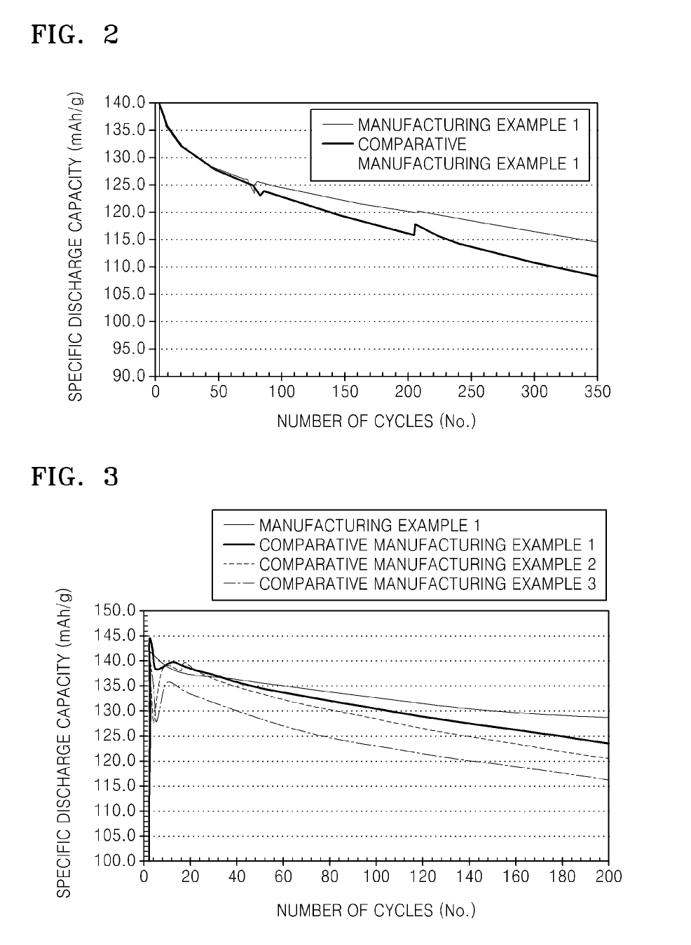

Charge and discharge characteristics of the rectangular cells prepared in Manufacturing Examples 1-3 and Comparative Manufacturing Example 1 were evaluated by a charger and discharger (TOYO-3100 available from TOYO Co., Tokyo, Japan) and lifespan characteristics were measured at room temperature (25° C.), the results of which are shown in FIG. 2.

A charge and discharge was performed at 0.1 C, a charge potential of 4.2 V (cut-off at 1/50), and a discharge potential of 3.0 V in the first cycle, and then at 0.2 C, a charge potential of 4.2 V (cut-off at 1/20), and a discharge potential of 3.0 V in the second cycle, and then at 0.5 C, a charge potential of 4.2 V (cut-off at 1/20), and a discharge potential of 3.0 V in the subsequent cycle.

Referring to FIG. 2, the rectangular cell of Manufacturing Example 1 showed improved lifespan characteristics at room temperature compared to that of the rectangular cell of Comparative Manufacturing Example 1.

### 2) COMPARATIVE MANUFACTURING EXAMPLES 1-3

Charge and discharge characteristics of the rectangular cells prepared in Manufacturing Examples 1 and Comparative Manufacturing Examples 1-3 were evaluated by a charger and discharger (TOYO-3100 available from TOYO) and lifespan characteristics were measured at room temperature (25° C.), the results of which are shown in FIG. 3.

A charge and discharge was performed at 0.1 C, a charge potential of 4.2 V (cut-off at 1/50), and a discharge potential of 3.0 V in the first cycle, and then at 0.2 C, a charge potential of 4.2 V (cut-off at 1/20), and a discharge potential of 3.0 V in the second cycle, and then at 0.5 C, a charge potential of 4.2 V (cut-off at 1/20), and a discharge potential of 3.0 V in the subsequent cycle.

Referring to FIG. 3, Comparative Manufacturing Examples 1-3 showed reduced lifespan characteristics at room temperature compared to Manufacturing Example 1.

### EVALUATION EXAMPLE 2

### Evaluation of Lifespan Characteristics at High Temperature

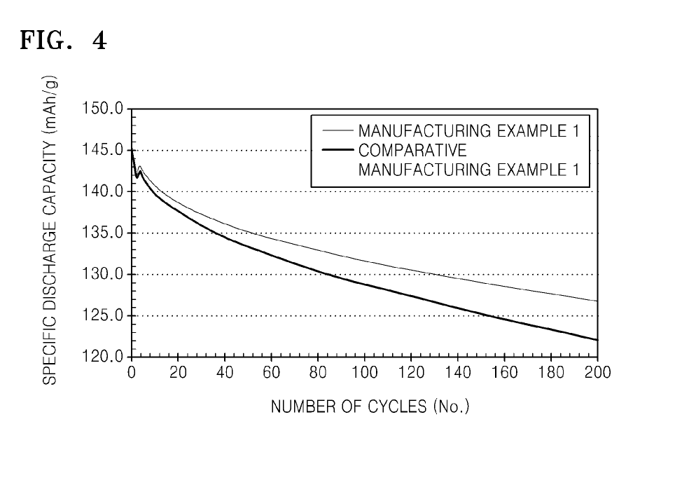

Charge and discharge characteristics of the rectangular cells prepared in Manufacturing Example 1 and Comparative Manufacturing Example 1 were evaluated by a charger and discharger (TOYO-3100 available from TOYO) and lifespan characteristics were measured at high temperature (45° C.), the results of which are shown in FIG. 4.

A charge and discharge was performed at 0.1 C, a charge potential of 4.2 V (cut-off at 1/50), and a discharge potential of 3.0 V in the first cycle, and then at 0.2 C, a charge potential of 4.2 V (cut-off at 1/20), and a discharge potential of 3.0 V in the second cycle, and then at 0.5 C, a charge potential of 4.2 V (cut-off at 1/20), and a discharge potential of 3.0 V in the subsequent cycle.

Referring to FIG. 4, the rectangular cell of Manufacturing Example 1 showed improved lifespan characteristics at high temperature compared to Comparative Manufacturing Example 1.

As described above, according to the one or more of the above embodiments of the present disclosure, when an electrolyte for a lithium secondary battery according to an embodiment of the present disclosure is used, a lithium secondary battery having improved lifespan characteristics may be prepared.

It should be understood that the exemplary embodiments described therein should be considered in a descriptive sense only and not for purposes of limitation. Descriptions of features or aspects within each embodiment should typically be considered as available for other similar features or aspects in other embodiments.

In the present disclosure, the terms “Example,” “Comparative Example” “Manufacturing Example,” “Comparative Manufacturing Example” and “Evaluation Example” are used arbitrarily to simply identify a particular example or experimentation and should not be interpreted as admission of prior art. While one or more embodiments of the present disclosure have been described with reference to the figures, it will be understood by those of ordinary skill in the art that various changes in form and details may be made therein without departing from the spirit and scope of the present embodiments as defined by the following claims.

What is claimed is:

1. An electrolyte for a lithium secondary battery, comprising:
a non-aqueous organic solvent;
a lithium salt; and
a compound of Formula 1: 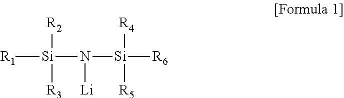
wherein in Formula 1, R₁ to R₆ are each independently a substituted or unsubstituted C1-C30 alkyl group; and
wherein an amount of the compound represented by Formula 1 is about 0.1 wt % to about 3 wt % based on total amount of the electrolyte.

2. The electrolyte of claim 1, wherein in Formula 1, R₁ to R₆ are each independently a methyl group, an ethyl group, a propyl group, a pentyl group, or a hexyl group.

3. The electrolyte of claim 1, wherein the compound of Formula 1 is a compound of Formula 2:

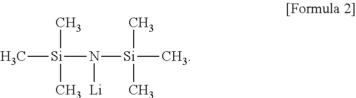

4. The electrolyte of claim 1, wherein the amount of the compound of Formula 1 is about 0.5 wt % to about 1 wt % based on total amount of the electrolyte.

5. The electrolyte of claim 1, wherein the non-aqueous organic solvent comprises a carbonate-based, an ester-based, an ether-based, a ketone-based, an alcohol-based, or an aprotic solvent.

6. The electrolyte of claim 1, wherein the non-aqueous organic solvent is at least one selected from dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), acetonitrile, succinonitrile, dimethyl sulfoxide, dimethyl formamide, dimethyl acetamide, gamma butyrolactone, and tetrahydrofuran.

7. The electrolyte of claim 1, wherein the lithium salt is LiPF₆, LiBF₄, LiSbF₆, LiAsF₆, LiC4F₉SO₃, LiClO₄, LiAlO₂, LiAlCl₄, LiN(CₓF₂ₓ₊₁SO₂)(C_{y}F_{2y+1}SO₂), LiCl, LiI, LiB(C₂O₄)₂ (lithium bis(oxalato)borate), or a combination thereof, wherein x and y are natural numbers of 1 to 20, respectively.

8. The electrolyte of claim 1, wherein a concentration of the lithium salt is about 0.1 M to about 2.0 M.

9. The electrolyte of claim 1, wherein the non-aqueous solvent comprises a mixture solvent of ethylene carbonate (EC) and ethylmethyl carbonate (EMC) or a mixture solvent of ethylene carbonate (EC), ethylmethyl carbonate (EMC), and diethylene carbonate (DEC).

10. The electrolyte of claim 9, wherein a volume ratio of ethylene carbonate (EC) and ethylmethyl carbonate (EMC) in the mixture solvent of ethylene carbonate (EC) and ethylmethyl carbonate (EMC) is 3:7, and a volume ratio of ethylene carbonate (EC), ethylmethyl carbonate (EMC), and diethylene carbonate (DEC) in the mixture solvent of ethylene carbonate (EC), ethylmethyl carbonate (EMC), and diethylene carbonate (DEC) is 3:5:2.

11. A lithium secondary battery comprising:
a positive electrode;
a negative electrode; and
a reaction product of an electrolyte, wherein the electrolyte comprises a non-aqueous organic solvent; a lithium salt; and compound of Formula 1: 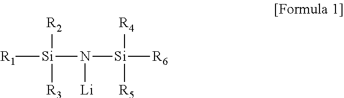
wherein in Formula 1, R₁ to R₆ are each independently a substituted or unsubstituted C₁-C₃₀ alkyl group; and
an amount of the compound represented by Formula 1 is about 0.1 wt % to about 3 wt % based on total amount of the electrolyte.

12. The lithium battery of claim 11, wherein in Formula 1, R₁ to R₆ are each independently a methyl group, an ethyl group, a propyl group, a pentyl group, or a hexyl group.

13. The lithium battery of claim 11, wherein the compound of Formula 1 is a compound of Formula 2:

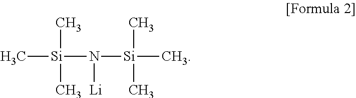

14. The lithium battery of claim 11, wherein the amount of the compound represented by Formula 1 is about 0.5 wt % to about 1 wt % based on total amount of the electrolyte.

15. The lithium battery of claim 11, wherein the non-aqueous organic solvent comprises a carbonate-based, an ester-based, an ether-based, a ketone-based, an alcohol-based, or an aprotic solvent.

16. The lithium battery of claim 11, wherein the non-aqueous organic solvent is at least one selected from dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), acetonitrile, succinonitrile, dimethyl sulfoxide, dimethyl formamide, dimethyl acetamide, gamma butyrolactone, and tetrahydrofuran.

17. The lithium battery of claim 11, wherein the lithium salt is LiPF₆, LiBF₄, LiSbF₆, LiAsF₆, LiC4F₉SO₃, LiClO₄, LiAlO₂, LiAlCl₄, LiN(CₓF₂ₓ₊₁SO₂)(C_{y}F_{2y+1}SO₂), LiCl, LiI, LiB(C₂O₄)₂ (lithium bis(oxalato)borate), or a combination thereof, wherein x and y are natural numbers of 1 to 20, respectively.

18. The lithium battery of claim 11, wherein a concentration of the lithium salt is about 0.1 M to about 2.0 M.

19. The lithium battery of claim 11, wherein the non-aqueous solvent comprises a mixture solvent of ethylene carbonate (EC) and ethylmethyl carbonate (EMC) or a mixture solvent of ethylene carbonate (EC), ethylmethyl carbonate (EMC), and diethylene carbonate (DEC).

20. The lithium battery of claim 19, wherein a volume ratio of ethylene carbonate (EC) and ethylmethyl carbonate (EMC) in the mixture solvent of ethylene carbonate (EC) and ethylmethyl carbonate (EMC) is 3:7, and a volume ratio of ethylene carbonate (EC), ethylmethyl carbonate (EMC), and diethylene carbonate (DEC) in the mixture solvent of ethylene carbonate (EC), ethylmethyl carbonate (EMC), and diethylene carbonate (DEC) is 3:5:2.
